(19) United States
(12) Patent Application Publication
(10) Pub. No.: US 2004/0077479 A1
(43) Pub. Date: Apr. 22, 2004

(54) Coloured soda-lime glass of high light transmission

(76) Inventors: Dominique Coster, Temploux (BE); Laurent Delmotte, Meeffe (BE); Marc Foguenne, Saint-Denis (BE)

Correspondence Address: Supervisor, Patent Prosecution Service, Piper Rudnick, 1200 Nineteenth Street N W, Washington, DC, 20036-2412, US

(21) Appl. No.: 10/240,854

(22) PCT Filed: Mar. 28, 2001
(86) PCT No.: PCT/EP01/03506

(51) Int. Cl. C03C 3/087

(52) U.S. Cl. 501/71

(57) ABSTRACT

The present invention relates to a coloured soda-lime glass of high light transmission. It comprises less than 0.4% by weight of total amount of iron, expressed in the form of Fe₂O₃, has a redox ratio of at least 30% with an FeO content of at least 0.08% by weight and comprises in total at least 5 ppm and at most 1500 ppm by weight with respect to the total weight of glass of at least one of the following colouring agents in the respective amounts indicated: Cr₂O₃ from 0 to 500 ppm, V₂O₅ from 0 to 1000 ppm, Co from 0 to 100 ppm and Se from 0 to 10 ppm. This glass is suitable as glazing for motor vehicles and as glazing intended for buildings.

The present invention relates to a coloured soda-lime glass of high light transmission, composed of glass-forming principal constituents and of colouring agents.

The expression “soda-lime glass” is used here in the wide sense and relates to any glass which contains the following constituents (in percentages by weight):

| | |
|---|---|
| Na₂O | 10 to 20% |
| CaO | 0 to 16% |
| SiO₂ | 60 to 75% |
| K₂O | 0 to 10% |
| MgO | 0 to 10% |
| Al₂O₃ | 0 to 5% |
| BaO | 0 to 2% |
| BaO + CaO + MgO | 10 to 20% |
| K₂O + Na₂O | 10 to 20%. |

This type of glass is very widely used in the field of glazing for buildings or automobiles. It is usually manufactured in the form of a ribbon by the float process. Such a ribbon can be cut into sheets which can then be bent or can undergo a treatment to improve their mechanical properties, for example a thermal toughening step.

It is generally necessary to relate the optical properties of a glass sheet to a standard illuminant. In the present description, 2 standard illuminants are used, namely illuminant C and illuminant A defined by the Commission Internationale de l'Eclairage (C.I.E.). Illuminant C represents average daylight having a colour temperature of 6700 K. This illuminant is especially useful for evaluating the optical properties of glazing intended for buildings. Illuminant A represents the radiation of a Planck radiator with a temperature of about 2856 K. This illuminant describes the light emitted by car headlights and is essentially intended to evaluate the optical properties of glazings intended for automobiles. The Commission Internationale de l'Eclairage has also published a document entitled “Colorimétrie, Recommandations Officielles de la C.I.E. [Colorimetry and Official Recommendations of the C.I.E.]” (May 1970) which describes a theory in which the colorimetric co-ordinates for light of each wavelength of the visible spectrum are defined so as to be able to be represented on a diagram having orthogonal axes x and y, called the C.I.E. trichromaticity plot. This trichromaticity plot shows the locus representative of light of each wavelength (expressed in nanometers) of the visible spectrum. This locus is called the “spectrum locus” and light whose co-ordinates lie on this spectrum locus is said to have 100% excitation purity for the appropriate wavelength. The spectrum locus is closed by a line called the purple boundary which connects the points of the spectrum locus whose co-ordinates correspond to wavelengths of 380 nm (violet) and 780 nm (red). The area lying between the spectrum locus and the purple boundary is that available for the trichromaticity co-ordinates of any visible light. The co-ordinates of the light emitted by illuminant C, for example, correspond to x=0.3101 and y=0.3162. This point C is regarded as representing white light and consequently has an excitation purity equal to zero for any wavelength. Lines may be drawn from the point C to the spectrum locus at any desired wavelength and any point lying on these lines may be defined not only by its x and y co-ordinates but also as a function of the wavelength corresponding to the line on which it lies and on its distance from the point C relative to the total length of the wavelength line. Consequently, the colour of the light transmitted by a coloured glass sheet may be described by its dominant wavelength and its excitation purity expressed as a percentage.

The C.I.E. co-ordinates of light transmitted by a coloured glass sheet will depend not only on the composition of the glass but also on its thickness. In the present description, and in the claims, all the values of the excitation purity P and of the dominant wavelength λ_{D} of the transmitted light are calculated from the spectral specific internal transmissions (SIT_{λ}) of a glass sheet 5 mm in thickness with illuminant C under a solid viewing angle of 2°. The spectral specific internal transmission of a glass sheet is governed solely by the absorption of the glass and can be expressed by the Beer-Lambert law:

SIT_{λ}=e^{-E.A}^{_{λ}}where A_{λ}is the absorption coefficient (in cm⁻¹) of the glass at the wavelength in question and E is the thickness (in cm) of the glass. To a first approximation, SIT_{λ}may also be represented by the formula:

(I₃+R₂)/(I₁−R₁)

where I₁ is the intensity of the incident visible light on a first face of the glass sheet, R₁ is the intensity of the visible light reflected by this face, I₃ is the intensity of the visible light transmitted from the second face of the glass sheet and R₂ is the intensity of the visible light reflected by this second face towards the interior of the sheet.

In the description which follows and in the claims, the following are also used:

for illuminant A, the total light transmission (TLA) measured for a thickness of 4 mm (TLA4) under a solid viewing angle of 2°. This total transmission is the result of the integration between the 380 and 780 nm wavelengths of the expression: ΣT_{λ}.E_{λ}. S_{λ}/ΣE_{λ}.S_{λ} in which T_{λ} is the transmission at the wavelength λ, E_{λ} is the spectral distribution of illuminant A and S_{λ} is the sensitivity of the normal human eye as a function of the wavelength λ;

the total energy transmission (TE) measured for a thickness of 4 mm (TE4). This total transmission is the result of the integration between the 300 and 2500 nm wavelengths of the expression: ΣT_{λ}.E_{λ}/ΣE_{λ} in which E_{λ} is the spectral energy distribution of the sun at 30° above the horizon;

the selectivity (SE) measured as the ratio of the total light transmission for illuminant A to the total energy transmission (TLA/TE);

the total transmission in the ultraviolet, measured for a thickness of 4 mm (TUV4). This total transmission is the result of the integration between 280 and 380 nm of the expression: ΣT_{λ}.U_{λ}/ΣU_{λ} in which U_{λ} is the spectral distribution of the ultraviolet radiation that has passed through the atmosphere, defined in the DIN 67507 standard.

the redox ratio, which represents the value of the Fe²⁺/total Fe ratio, is obtained by the formula:

Fe²⁺/totalFe=[24.4495×log(92/τ₁₀₅₀)]/t-Fe₂O₃

where τ₁₀₅₀ represents the specific internal transmission of the 5 mm-thick glass at the 1050 nm wavelength and t-Fe₂O₃ represents the total iron content expressed in Fe₂O₃ oxide form and measured by X-ray fluorescence.

The present invention relates in particular, but not exclusively, to blue-tinted glasses. These glasses can be used in architectural applications and as glazing for railway carriages and motor vehicles. In architectural applications, glass sheets 4 to 6 mm in thickness are generally used while in the motor-vehicle field thicknesses of 1 to 5 mm are normally employed, particularly for the production of monolithic glazing, and thicknesses of between 1 and 3 mm in the case of laminated glazing, especially for windscreens, two glass sheets of this thickness then being bonded together by means of an interlayer film, generally made of polyvinyl butyral (PVB).

The present demand for coloured glazing is focused on products having, for a given light transmission level, a pronounced coloration, that is to say a high excitation purity, even for high light transmission levels, while still providing moderate transmission levels for ultraviolet and infrared radiation.

In the field of motor-vehicle glazing applications in particular, it is important for the glazing to have a high light transmission allowing optimum visibility so as to meet demanding criteria relating to road safety. These glasses of high light transmission can be obtained with a composition containing a small total amount of Fe. However, it is difficult in this case to obtain a glass whose tint is sufficiently pronounced and whose energy transmission is lower than ordinary glass, for a given light transmission, so as to reduce the influx of heat into the vehicle and thus to reduce the risk of overheating the passenger compartment.

We have found that it is possible, by a judicious choice of several specific colouring agents in combination with a defined redox ratio, to obtain glasses of high light transmission with a pronounced tint which are particularly well suited as motor-vehicle glazing.

The invention consequently relates to a coloured soda-lime glass of high light transmission, composed of glass-forming principal constituents and of colouring agents, the amount of which is expressed by weight with respect to the total weight of glass, characterized in that it comprises a total amount of iron, expressed in the form of Fe₂O₃ oxide, which is less than 0.4% by weight and in that it has a redox ratio of at least 30% with an FeO content of at least 0.08% by weight and in that it comprises in total at least five parts per million (ppm) and at most 1500 ppm by weight of at least one of the following colouring agents in the respective amounts indicated, expressed by weight with respect to the total weight of glass:

| | |
|---|---|
| Cr₂O₃ | from 0 to 500 ppm |
| V₂O₅ | from 0 to 1000 ppm |
| Co | from 0 to 100 ppm |
| Se | from 0 to 10 ppm. |

The invention provides a choice of glasses of high light transmission from which it is easy to find glasses having a pronounced shade of colour and a reduced infrared transmission, while still being able to be obtained easily in conventional industrial glass furnaces.

It is surprising that a composition containing a small amount of iron can result, by judiciously choosing a small amount of one or more other colouring agents, in a glass which meets the commercial requirement specified above. This is because, hitherto a person skilled in the art has been unable to achieve such a combination of properties. It seems that the choice of a relatively high, greater than 30%, redox ratio is a key element, in combination with the selection of the colouring agents, for achieving the present invention. However, a high redox ratio is more difficult to obtain for a low total iron content. In addition, when this ratio is very high, and especially when it becomes greater than 60%, the chemical reactions in the molten glass pool become more difficult to control.

The light transmission (TLA4) of the coloured glass according to the invention may be greater than 60%, preferably greater than or equal to 66%.

Advantageously a coloured glass according to the invention has a light transmission (TLA4) greater than or equal to 70%, preferably greater than or equal to 72% and even more advantageously greater than or equal to 75%, making it particularly suitable for use as motor-vehicle glazing, and especially for windscreens.

Preferably, a coloured glass according to the invention has a tint in transmission which has a dominant wavelength (λ_{D}) of less than 494 nm, advantageously less than 492 nm and ideally less than 490 nm.

The invention thus provides a glass whose tint falls well within the blue range, thus easily meeting the commercial requirement for obtaining the desired aesthetic appearance for all motor-vehicle glazing with a shade of blue especially pleasing to the eye. This tint is also highly desirable in the field of architectural applications, particularly with a high light transmission. Glazing with a bulk-tinted glass according to the invention and comprising a solar-protection layer and/or a low-emissivity layer advantageously combines an attractive appearance with particularly favourable thermal characteristics.

The glass according to the invention also has the advantage of having a particularly high colour rendition index (Rₐ), that is to say the colours observed through the glass according to the invention are not distorted or may be very slightly distorted.

Preferably, the tint in transmission of the coloured glass according to the invention has an excitation purity (P) greater than 3% and preferably greater than 5%. The tint is thus very pronounced, although the light transmission of the glass is high.

In addition, the glasses according to the invention have the, advantage of combining a blue colour with a high selectivity. Thus, the selectivity (SE) of a coloured glass according to the invention is preferably greater than or equal to 1.2. A selectivity (SE) greater than 1.3, for example between 1.6 and 1.7, may be easily achieved. This property is particularly advantageous both for motor-vehicle applications and architectural applications, since it makes it possible to limit the heating due to solar radiation and therefore to increase the thermal comfort of the passengers of the vehicle or of the building, while still providing high natural illumination and unattenuated visibility through the glazing.

In fact, we have found that such a selection of optical and thermal properties has never yet been able to be achieved and a glass combining these various properties is particularly advantageous.

This is why, according to another aspect of the invention, the invention relates to a blue-coloured soda-lime glass of high light transmission, composed of glass-forming principal constituents and of colouring agents, the amounts of which are expressed by weight with respect to the total weight of glass, characterized in that it comprises a total amount of iron, expressed in the form of Fe₂O₃ oxide, which is less than 0.4% by weight, in that its tint in transmission has a dominant wavelength (λ_{D}) of less than 494 nm with a light transmission (TLA4) greater than 66%, an excitation purity (P) greater than 3% and a selectivity (SE) greater than 1.2.

It is surprising that a glass of high light transmission, with a low total iron content, can have a relatively pronounced blue tint in transmission, meeting particularly desirable aesthetic criteria, and can at the same time have a high selectivity allowing the energy transmission to be significantly reduced while ensuring perfect visibility through the glass. We have found that this glass can be obtained, surprisingly, by a judicious choice of a few colouring agents and it can be easily manufactured in industrial furnaces.

The glass according to the other aspect of the invention may have a light transmission greater than 66%, for example greater than 68%, but preferably it has a light transmission (TLA4) greater than or equal to 70%. Such a glass is suitable for motor-vehicle applications requiring a specific light transmission level. It is even more surprising to obtain the properties specified above with such a high light transmission.

According to the other aspect of the invention, the coloured glass preferably has a redox ratio of at least 30%. Such a redox ratio value is favourable to obtaining a high selectivity.

According to the other aspect of the invention, the coloured glass preferably comprises at least one of the following colouring agents in the respective amounts indicated, expressed by weight with respect to the total weight of glass:

| | |
|---|---|
| Cr₂O₃ | from 0 to 500 ppm |
| V₂O₅ | from 0 to 1000 ppm |
| Co | from 0 to 100 ppm |
| Se | from 0 to 10 ppm. |

The description which follows applies to all aspects of the invention.

Iron is a colouring agent widely used in the field of coloured glasses. The presence of Fe³⁺ gives the glass a slight absorption of visible light of short wavelength (410 and 440 nm) and a very strong absorption band in the ultraviolet (absorption band centred on 380 nm), whereas the presence of Fe²⁺ ions causes a strong absorption in the infrared (absorption band centred on 1050 nm). The ferric ions give the glass a slight yellow coloration, whereas the ferrous ions give a more pronounced blue-green coloration. All other considerations being equal, it is the Fe²⁺ ions which are responsible for the absorption in the infrared range and which therefore determine the total energy transmission TE.

The effects of the various colouring agents individually envisaged for producing a glass are the following (according to “Le Verre” [Glass] by H. Scholze, translated by J. Le Dû, Institut du Verre [Glass Institute], Paris):

Cobalt: the Co^{II}O₄ group produces an intense blue coloration with a dominant wavelength almost opposite to that produced by the iron-selenium chromophor.

Chromium: the presence of the Cr^{III}O₆ group gives rise to absorption bands at 650 nm and a light green colour. More extensive oxidation gives rise to the Cr^{VI}O₄ group which creates a very intense absorption band at 365 nm and gives a yellow coloration.

Cerium: the presence of cerium ions in the composition makes it possible to obtain a strong absorption in the ultraviolet range. Cerium oxide exists in two forms: Ce^{IV} absorbs in the ultraviolet around 240 nm and Ce^{III} absorbs in the ultraviolet around 314 nm.

Selenium: the Se⁴⁺ cation has virtually no colouring effect, whereas the uncharged element SeO gives a pink coloration. The Se²⁻ anion forms a chromophor with the ferric ions present and consequently gives the glass a brown-red colour.

Vanadium: for increasing contents of alkali metal oxides, the colour changes from green to colorless, this being caused by the oxidation of the V^{III}O₆ group into V^{V}O₄.

Manganese: appears in the glass in the form of practically colourless Mn^{II}O₆. The Mn^{III}O₆ group in glasses rich in alkali metals creates, however, a violet colour.

Titanium: TiO₂ in the glasses gives them a yellow coloration. In large amounts, it is even possible to obtain, by reduction, the Ti^{III}O₆ group, which gives the glass a violet or even maroon colour.

The thermal and optical properties of a glass containing several colouring agents are therefore the result of a complex interaction between them. In fact, the behaviour of these colouring agents depends greatly on their oxidation state and therefore on the presence of other elements liable to influence this state.

The coloured glass according to the invention preferably comprises an amount of TiO₂ colouring agent of less than 2% by weight with respect to the total weight of glass, or even more preferably less than 1% by weight. This colouring agent, in combination with a colouring agent or colouring agents required by the invention, makes it possible to obtain particular tints for specific applications. It also has the particular advantage of reducing the transmission of ultraviolet radiation through the glass.

The glass according to the invention advantageously comprises less than 0.5% by weight of TiO₂, preferably less than 0.3% by weight of TiO₂, ideally less than 0.1% by weight of TiO₂. A higher amount of TiO₂ runs the risk of giving the glass a yellow coloration which goes against the tint desired here. In fact, the TiO₂ in the glass according to the invention is preferably be present only as an impurity, without being deliberately added.

The coloured glass according to the invention preferably comprises an amount of the colouring agent CeO₂ of less than 2% by weight with respect to the total weight of glass, or even preferably less than 1% by weight. This colouring agent is advantageous in the sense that it allows the transmission of ultraviolet radiation through the glass to be reduced.

However, this element has a tendency to shift the dominant wavelength towards the green and when it is present in too great an amount its effect goes against the preferred tint according to the invention.

In addition, CeO₂ is a very expensive element and its use even in amounts not exceeding 1% by weight of CeO₂ in the glass may double the cost of the batch materials necessary for manufacturing.

This is why the glass according to the invention advantageously comprises less than 0.5% by weight of CeO₂ among its colouring agents, preferably less than 0.3% by weight of CeO₂ and ideally less than 0.1% by weight of CeO₂.

The coloured glass according to the invention preferably comprises at most 50 ppm of Co. Too high an amount of Co is unfavourable to achieving a high selectivity (SE).

Advantageously, the glass according to the invention comprises no more than 0.13% of MnO₂ among its colouring agents. MnO₂ has an oxidizing character which runs the risk of creating a green tint by modifying the redox state of the iron if it is used in a higher amount. Preferably, the glass according to the invention will comprise less than 0.10% by weight of MnO₂ and ideally less than 0.05% by weight of MnO₂.

It is also desirable for the glass according to the invention to comprise an amount of fluorinated compounds among its colouring agents of less than 0.2% by weight with respect to the total weight of glass. This is because these compounds give rise to discharges from the furnace which are very harmful to the environment and are, in addition, highly corrosive with respect to the blocks of refractory materials which line the inside of the said furnace.

Moreover, it is preferred that the glass according to the present invention be obtained from a mixture of principal glass-forming constituents comprising an amount of MgO greater than 2% by weight since this compound encourages the melting of the said constituents.

In preferred forms of the invention, the glass comprises the following amounts of colouring agents, expressed by weight of colouring agent with respect to the total weight of glass, the total amount of iron being expressed in the form of Fe₂O₃:

| | |
|---|---|
| Fe₂O₃ | from 0.27% to less than 0.4% |
| FeO | from 0.10% to 0.20% |
| Co | from 1 ppm to 35 ppm |
| Cr₂O₃ | from 0 to 250 ppm |
| V₂O₅ | from 0 to 450 ppm |

and has the following optical properties:

```
70.5% < TLA4 < 85%
  40% < TE4 < 60%
    P > 3%
  λ_{D} ≦ 492 nm.
```

Glasses having such characteristics are particularly suitable for a large number of motor-vehicle applications, particularly as windscreens, and for architectural applications. The optical properties obtained correspond to selective products, that is to say to products having, for a given tight transmission level, a low energy transmission level. This limits the extent to which volumes bounded by glazing manufactured from such glasses are heated up. The transmission purity thus defined is also suitable for such applications.

The coloured glass according to the invention preferably forms glazing for motor vehicles. It may, for example, be advantageously used as side windows or as a windscreen of a vehicle.

The glass according to the invention may be coated with a layer of metal oxides which reduce the extent to which it is heated up by solar radiation and consequently the extent to which the passenger compartment of a vehicle using such glass as glazing is heated up.

The glasses according to the invention can be manufactured by conventional processes. As batch materials, it is possible to use natural materials, recycled glass, slag or a combination of these materials. The colouring agents are not necessarily added in the form indicated, but this way of giving the amounts of colouring agents added, in equivalents in the forms indicated, corresponds to the standard practice. In practice, the iron is added in the form of red iron oxide, the cobalt is added in the form of the hydrated sulphate, such as CoSO₄.7H₂O or CoSO₄.6H₂O and the chromium is added in the form of the dichromate such as K₂Cr₂O₇. The cerium is introduced in the form of the oxide or carbonate. As regards the vanadium, it is introduced in the form of vanadium oxide or sodium vanadate. The selenium, when it is present, is added in elemental form or in selenite form such as Na₂SeO₃ or ZnSeO₃.

Other elements, such as nickel, are sometimes present as impurities in the batch materials used to manufacture the glass according to the invention, whether in natural materials, in recycled glass or in slag, but when these impurities do not give the glass properties lying outside the limits defined above, these glasses are regarded as being in accordance with the present invention. The present invention will be illustrated by the following specific examples of optical properties and compositions, which examples cannot be regarded as limiting our present invention.

### EXAMPLES 1 to 59

Table I gives by way of non-limiting indication the base composition of the glass and the constituents of the batch to be melted in order to produce the glasses according to the invention. Of course, a glass having the same optical and energy properties may be obtained with a base composition having amounts of oxides falling within the ranges of percentages by weight given at the beginning of the present description. Table II gives the proportions of colouring agents and the optical properties of glasses according to the invention. The above mentioned proportions are determined by X-ray fluorescence of the glass and converted into the molecular species indicated.

Table II clearly shows that the invention provides a choice of coloured glasses of high light transmission with a pronounced blue tint, for example a TLA4 of 76.6% at a dominant wavelength λ_{D}=487.5 nm with an excitation purity P of 7.3% (Example No. 1), having a high selectivity SE (1.4 in the case of Example 1). These glasses have a very attractive appearance, particularly useful as motor-vehicle glazing.

In the case of Example No. 28, the overall colour rendition index Rₐ for a glass 4 mm in thickness was measured, according to EuropeanStandard EN410 to be 92.2%. This is regarded as a very good colour rendition and gives a very faithful perception of the colour observed through the glass.

The batch may, if necessary, contain a reducing agent such as coke, graphite, slag or an oxidizing agent such as a nitrate. In this case, the proportions of the other materials are adapted so that the composition of the glass remains unchanged.

TABLE I

| | |
|---|---|
| Composition of the base glass | Constituents of the base glass |

| | | | |
|---|---|---|---|
| SiO₂ | 71.5 to 71.9% | Sand | 571.3 |
| Al₂O₃ | 0.8% | Feldspar | 29.6 |
| CaO | 8.8% | Lime | 35.7 |
| MgO | 4.2% | Dolomite | 167.7 |
| Na₂O | 14.1% | Na₂CO₃ | 189.4 |
| K₂O | 0.1% | Sulphate | 5.0 |
| SO₃ | 0.05 to 0.45% | | |

TABLE II

| Ex. | Fe₂O₃ | Co | V₂O₅ | Cr₂O₃ | Se | FeO | Redo | TLA4 | TE4 | TUV4 | | λ_{D} | P |
|---|---|---|---|---|---|---|---|---|---|---|---|---|---|
| No. | (%) | (ppm) | (ppm) | (ppm) | (ppm) | (%) | x (%) | (%) | (%) | (%) | SE | (nm) | (%) |
| 1 | 0.35 | 12 | 10 | 6 | | 0.120 | 38.0 | 76.6 | 54.8 | 36.5 | 1.40 | 487.5 | 7.3 |
| 2 | 0.395 | 12 | | 5 | | 0.117 | 33.0 | 77.9 | 58.1 | 36.3 | 1.34 | 489.3 | 5.4 |
| 3 | 0.35 | 14 | 50 | 50 | | 0.111 | 35.0 | 76.2 | 55.9 | 36.2 | 1.36 | 489.4 | 6.4 |
| 4 | 0.38 | 11 | 0 | 0 | | 0.120 | 35.0 | 77.3 | 55.6 | 35.1 | 1.39 | 488.2 | 6.4 |
| 5 | 0.38 | 5 | 7 | 5 | | 0.135 | 40.0 | 77.3 | 53.2 | 35.6 | 1.45 | 489.3 | 6.6 |
| 6 | 0.38 | 10 | | 6 | | 0.120 | 35.0 | 77.5 | 55.7 | 35.1 | 1.39 | 488.7 | 6.2 |
| 7 | 0.38 | 0 | 2 | 3 | | 0.113 | 33.0 | 81.1 | 57.8 | 34.9 | 1.40 | 493.6 | 3.7 |
| 8 | 0.38 | 13 | | 6 | | 0.110 | 32.0 | 77.7 | 57.3 | 34.9 | 1.36 | 488.3 | 5.9 |
| 9 | 0.39 | 14 | | 3 | | 0.121 | 34.5 | 76.9 | 57.2 | 36.7 | 1.35 | 488.3 | 6.2 |
| 10 | 0.30 | 15 | | 203 | | 0.108 | 39.8 | 73.3 | 53.5 | 40.7 | 1.37 | 493.6 | 6.7 |
| 11 | 0.37 | 1 | 5 | 3 | | 0.141 | 42.3 | 77.8 | 52.3 | 38.0 | 1.49 | 489.9 | 6.5 |
| 12 | 0.36 | 5 | 200 | 2 | | 0.123 | 38.0 | 77.8 | 54.8 | 38.1 | 1.42 | 490.4 | 5.7 |
| 13 | 0.28 | 28 | | 250 | | 0.087 | 34.6 | 71.1 | 55.9 | 41.1 | 1.27 | 492.6 | 7.1 |
| 14 | 0.27 | 35 | 410 | 3 | | 0.093 | 38.1 | 70.7 | 55.5 | 41.8 | 1.28 | 484.0 | 11.1 |
| 15 | 0.33 | 8 | 210 | 105 | | 0.134 | 45.2 | 73.6 | 50.2 | 39.8 | 1.46 | 491.9 | 7.4 |
| 16 | 0.29 | 14 | 75 | 135 | | 0.098 | 37.5 | 75.5 | 56.0 | 40.9 | 1.35 | 492.2 | 6.1 |
| 17 | 0.35 | 21 | | | | 0.146 | 46.4 | 71.1 | 48.8 | 39.1 | 1.46 | 485.3 | 11.6 |
| 18 | 0.35 | 24 | 2 | 98 | | 0.123 | 39.5 | 71.3 | 52.1 | 38.9 | 1.37 | 488.0 | 9.2 |
| 19 | 0.37 | 11 | | | | 0.183 | 55.0 | 70.5 | 43.5 | 38.9 | 1.62 | 486.5 | 12.1 |
| 20 | 0.37 | 4 | | | 3 | 0.171 | 52.0 | 72.9 | 45.9 | 38.9 | 1.59 | 488.9 | 7.8 |
| 21 | 0.38 | 1 | | | 7 | 0.196 | 57.2 | 70.4 | 41.8 | 38.6 | 1.68 | 491.4 | 6.0 |
| 22 | 0.37 | 4 | | | 9 | 0.179 | 54.3 | 70.3 | 43.8 | 39.0 | 1.61 | 493.0 | 4.4 |
| 23 | 0.35 | 18 | | | 6 | 0.132 | 42.0 | 71.8 | 51.2 | 38.8 | 1.40 | 487.8 | 5.6 |
| 24 | 0.35 | 21 | | | 9 | 0.123 | 39.0 | 71.1 | 52.4 | 38.6 | 1.36 | 489.7 | 3.2 |
| 25 | 0.31 | 14 | | 58 | | 0.101 | 36.0 | 76.9 | 57.0 | 40.0 | 1.35 | 488.9 | 6.5 |
| 26 | 0.38 | 11 | | 25 | | 0.117 | 34.5 | 77.2 | 55.9 | 37.3 | 1.38 | 489.3 | 6.0 |
| 27 | 0.38 | 16 | | | | 0.106 | 31.0 | 77.2 | 57.7 | 36.8 | 1.34 | 487.2 | 6.2 |
| 28 | 0.38 | 14 | | | | 0.116 | 34.3 | 77.6 | 58.0 | 37.2 | 1.34 | 488.1 | 6.1 |
| 29 | 0.37 | 12 | | | | 0.127 | 38.0 | 76.9 | 56.0 | 37.7 | 1.37 | 487.9 | 6.8 |
| 30 | 0.37 | 8 | | | | 0.132 | 40.0 | 77.4 | 55.3 | 38.0 | 1.40 | 488.7 | 6.6 |
| 31 | 0.36 | 10 | | | | 0.125 | 39.0 | 77.5 | 56.2 | 38.4 | 1.38 | 488.2 | 6.6 |
| 32 | 0.36 | 11 | 256 | | | 0.112 | 35.0 | 77.8 | 58.3 | 38.1 | 1.33 | 489.9 | 5.4 |
| 33 | 0.35 | 18 | 301 | 43 | | 0.120 | 38.0 | 74.0 | 55.5 | 38.5 | 1.33 | 489.3 | 7.1 |
| 34 | 0.32 | 22 | 150 | 83 | | 0.121 | 42.0 | 72.1 | 53.7 | 40.0 | 1.34 | 488.4 | 8.8 |
| 35 | 0.37 | 12 | | | | 0.183 | 55.0 | 70.9 | 45.4 | 38.9 | 1.56 | 486.7 | 11.7 |
| 36 | 0.36 | 21 | | 75 | | 0.188 | 58.0 | 66.3 | 42.3 | 39.6 | 1.57 | 487.1 | 13.6 |
| 37 | 0.38 | 28 | | 89 | | 0.169 | 50.0 | 66.5 | 45.9 | 38.4 | 1.45 | 487.0 | 12.6 |
| 38 | 0.38 | 28 | 451 | | | 0.172 | 51.0 | 66.2 | 45.7 | 38.5 | 1.45 | 485.9 | 13.1 |
| 39 | 0.38 | 23 | 380 | 25 | | 0.176 | 52.0 | 67.1 | 45.3 | 38.5 | 1.48 | 487.0 | 12.2 |
| 40 | 0.36 | 23 | 150 | 182 | | 0.178 | 55.0 | 64.7 | 42.8 | 39.3 | 1.51 | 489.9 | 12.0 |
| 41 | 0.36 | 25 | 125 | 220 | | 0.191 | 59.0 | 62.2 | 39.8 | 39.6 | 1.56 | 489.9 | 13.2 |
| 42 | 0.36 | 25 | 220 | 75 | | 0.156 | 48.0 | 68.0 | 48.0 | 38.9 | 1.42 | 487.6 | 11.2 |
| 43 | 0.37 | 21 | 160 | 98 | | 0.150 | 45.0 | 69.8 | 49.7 | 38.2 | 1.41 | 489.2 | 9.5 |
| 44 | 0.38 | 24 | 155 | | | 0.154 | 45.0 | 70.2 | 49.9 | 37.8 | 1.41 | 485.9 | 11.0 |
| 45 | 0.36 | 23 | | 202 | | 0.188 | 58.0 | 63.8 | 40.9 | 39.6 | 1.56 | 489.6 | 12.9 |
| 46 | 0.35 | 35 | | 354 | | 0.15 | 48.0 | 61.8 | 45.2 | 39.5 | 1.37 | 492.3 | 11.0 |
| 47 | 0.25 | 41 | | 383 | | 0.11 | 47.0 | 62.4 | 48.9 | 43.3 | 1.28 | 491.5 | 11.3 |
| 48 | 0.26 | 51 | | 345 | | 0.09 | 38.0 | 63.0 | 53.6 | 42.2 | 1.17 | 489.9 | 11.1 |
| 49 | 0.24 | 38 | 748 | | | 0.08 | 35.0 | 71.4 | 60.0 | 42.8 | 1.19 | 484.4 | 9.7 |
| 50 | 0.28 | 33 | 710 | | | 0.11 | 45.0 | 68.4 | 52.5 | 41.9 | 1.30 | 485.3 | 11.7 |
| 51 | 0.24 | 25 | 950 | | | 0.08 | 38.0 | 73.5 | 59.0 | 43.0 | 1.25 | 487.4 | 7.6 |
| 52 | 0.32 | 18 | 843 | | | 0.140 | 48.0 | 70.3 | 50.2 | 40.4 | 1.40 | 488.3 | 9.5 |
| 53 | 0.385 | 9 | | | | 0.128 | 37.0 | 77.7 | 56.3 | 37.0 | 1.38 | 489.2 | 6.0 |
| 54 | 0.38 | 12 | | 3 | | 0.116 | 34.0 | 78.0 | 58.1 | 37.0 | 1.34 | 488.8 | 5.7 |
| 55 | 0.37 | 15 | | 5 | 4 | 0.133 | 40.0 | 74.1 | 54.0 | 37.9 | 1.37 | 489.3 | 5.2 |
| 56 | 0.39 | 15 | | 6 | | 0.123 | 35.0 | 76.4 | 56.8 | 36.7 | 1.35 | 488.0 | 6.6 |
| 57 | 0.39 | 19 | | 12 | | 0.130 | 37.0 | 74.5 | 55.1 | 36.8 | 1.35 | 487.1 | 7.9 |
| 58 | 0.385 | 14 | | | | 0.125 | 36.0 | 76.6 | 56.5 | 37.0 | 1.36 | 487.8 | 6.7 |
| 59 | 0.385 | 7 | | | | 0.128 | 37.0 | 78.3 | 56.5 | 37.0 | 1.39 | 489.8 | 5.6 |

1. Coloured soda-lime glass of high light transmission, composed of glass-forming principal constituents and of colouring agents, the amount of which is expressed by weight with respect to the total weight of glass, characterized in that it comprises a total amount of iron, expressed in the form of Fe₂O₃ oxide, which is less than 0.4% by weight and in that it has a redox ratio of at least 30% with an FeO content of at least 0.08% by weight and in that it includes in total at least five parts per million (ppm) and at most 1500 ppm by weight of at least one of the following colouring agents in the respective amounts indicated:

| | |
|---|---|
| Cr₂O₃ | from 0 to 500 ppm |
| V₂O₅ | from 0 to 1000 ppm |
| Co | from 0 to 100 ppm |
| Se | from 0 to 10 ppm. |

2. Coloured glass according to claim 1, characterized in that it has a light transmission (TLA4) greater than or equal to 66%.

3. Coloured glass according to claim 2, characterized in that it has a light transmission (TLA4) greater than or equal to 70%.

4. Coloured glass according to claim 3, characterized in that it has a light transmission (TLA4) greater than or equal to 72%, preferably greater than or equal to 75%.

5. Coloured glass according to any one of claims 1 to 4, characterized in that its tint in transmission has a dominant wavelength (λ_{D}) of less than 494 nm.

6. Coloured glass according to claim 5, characterized in that its tint in transmission has a dominant wavelength (λ_{D}) of less than 492 nm.

7. Coloured glass according to claim 6, characterized in that its tint in transmission has a dominant wavelength (λ_{D}) of less than 490 nm.

8. Coloured glass according to any one of claims 1 to 7, characterized in that its tint in transmission has an excitation purity (P) greater than 3%, preferably greater than 5%.

9. Coloured glass according to any one of claims 1 to 8, characterized in that it has a selectivity (SE) greater than or equal to 1.2.

10. Blue-coloured soda-lime glass of high light transmission, composed of glass-forming principal constituents and of colouring agents, characterized in that it comprises a total amount of iron, expressed in the form of Fe₂O₃ oxide, which is less than 0.4% by weight, in that its tint in transmission has a dominant wavelength (λ_{D}) of less than 494 nm with a light transmission (TLA4) greater than 66%, an excitation purity (P) greater than 3% and a selectivity (SE) greater than 1.2.

11. Coloured glass according to claim 10, characterized in that it has a light transmission (TLA4) greater than or equal to 70%.

12. Coloured glass according to either of claims 10 and 11, characterized in that it has a redox ratio of at least 30%.

13. Coloured glass according to any one of claims 10 to 12, characterized in that it comprises at least one of the following colouring agents in the respective amounts indicated, expressed by weight with respect to the total weight of glass:

| | |
|---|---|
| Cr₂O₃ | from 0 to 500 ppm |
| V₂O₅ | from 0 to 1000 ppm |
| Co | from 0 to 100 ppm |
| Se | from 0 to 10 ppm. |

14. Coloured glass according to any one of claims 1 to 13, characterized in that it comprises less than 0.3% by weight of TiO₂ with respect to the total weight of glass.

15. Coloured glass according to claim 14, characterized in that it comprises less than 0.1% by weight of TiO₂ with respect to the total weight of glass.

16. Coloured glass according to any one of claims 1 to 15, characterized in that it comprises less than 0.3% by weight of CeO₂ with respect to the total weight of glass.

17. Coloured glass according to claim 16, characterized in that it comprises less than 0.1% by weight of CeO₂ with respect to the total weight of glass.

18. Coloured glass according to any one of claims 1 to 17, characterized in that it comprises at most 50 ppm by weight of Co with respect to the total weight of glass.

19. Coloured glass according to any one of claims 1 to 18, characterized in that it comprises more than 2% by weight of MgO.

20. Coloured glass according to any one of claims 1 to 19, characterized in that it comprises the amounts of the following colouring agents, expressed by weight with respect to the total weight of glass, the total amount of iron being expressed in the form of Fe₂O₃:

| | |
|---|---|
| Fe₂O₃ | from 0.27% to less than 0.4% |
| FeO | from 0.10% to 0.20% |
| Co | from 1 ppm to 35 ppm |
| Cr₂O₃ | from 0 to 250 ppm |
| V₂O₅ | from 0 to 450 ppm |

and has the following optical properties:
```
70.5% < TLA4 < 85%
  40% < TE4 < 60%
    P > 3%
  λ_{D} ≦ 492 nm.
```

21. Coloured glass according to any one of claims 1 to 20, characterized in that it forms glazing for motor vehicles.

22. Coloured glass according to any one of claims 1 to 20, characterized in that it forms glazing for buildings.
